(19) United States
(12) Patent Application Publication
(10) Pub. No.: US 2008/0147626 A1
(43) Pub. Date: Jun. 19, 2008

(54) METHOD, COMPUTER PROGRAM PRODUCT, AND SYSTEM FOR MINING DATA

(75) Inventor: Michael J. Lapointe, Poughkeepsie, NY (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/611,189

(22) Filed: Dec. 15, 2006

(51) Int. Cl. G06F 7/06; G06F 17/30

(52) U.S. Cl. 707/4; 707/E17.017

(57) ABSTRACT

Data is mined based on empty query results. An empty query result provided in response to a query for data on a shared communications network is detected, and data associated with at least one term within the query is assembled. At least one entity associated with the assembled data is determined, and contact with the entity is initiated to invite posting of the data on the shared communications network. There may be a number or frequency cut-off, such that data is assembled, and the associated entity is contacted only after the empty query result occurs a predetermined number of times within a predetermined time period.

### BACKGROUND

The present disclosure relates generally to querying, in particular to mining data using query results.

Shared communications networks, such as the Internet, have become a powerful tool for users to search for information. In order to perform a search, a user submits a query containing one or more query terms. A query search program, commonly referred to as a “search engine”, processes the query to identify items on website that match the terms of the query. The items identified by the query server program are collectively referred to as the “query results”. The query results are typically displayed to the user as a list of items, ordered in various ways.

Though the amount of information available on the Internet continues to grow dramatically, occasionally a user may enter a query for which there is no match. The response to this type of query is referred to as an “empty result”. This may happen, for example, if the user submits a detailed query or if a user mistypes a term in a query. Of course, it may also be the case that information relating to the query is just not available via the Internet. For example, some information may be known by “word of mouth”, e.g., information regarding a local event, but such information may not have been posted on a website such that a search engine can find it.

When no items match the query entered by a user, the user may be presented with a prompt to correct the query, or the user may be presented with items that match only a portion of the query. In either case, the user ultimately may not be able to find the information he or she is looking for via the Internet. Also, an entity that may have information that the user is looking for loses the opportunity to provide that information via the Internet.

Thus, there is a need to use empty result queries to build information on shared communication networks, such as the Internet.

### SUMMARY

According to exemplary embodiments, a method, computer program product, and device are provided for mining data based on empty query results. An empty query result provided in response to a query for data on a shared communications network is detected, and data associated with at least one term within the query is assembled. At least one entity associated with the assembled data is determined, and contact with the entity is initiated to invite posting of the data on the shared communications network. There may be a number or frequency cut-off for the empty query result, such that data is assembled, and the associated entity is contacted only after the empty query result occurs a predetermined number of times within a predetermined time period.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a system in which data mining may be implemented according to an exemplary embodiment.

FIG. 2 illustrates details of a device for mining data according to an exemplary embodiment.

FIGS. 3A and 3B illustrate methods for data mining according to exemplary embodiments.

The detailed description explains exemplary embodiments, together with advantages and features, by way of example with reference to the drawings.

### DETAILED DESCRIPTION

According to exemplary embodiments, data is mined based on queries to a shared communications network, such as the Internet, which result in no matches. Though these queries result in “empty” or “zero” results being returned, there may exist information matching the query that is just not currently available on the communications network on which the search was performed. According to exemplary embodiments, data may be “mined” from sources having data matching the query and posted on the communications network, such that future queries for the data will not result in empty results.

According to an exemplary embodiment, filters or limits for empty results may be established, and follow up action may be initiated for high-count empty results queries. For example, a predetermined number of empty results may be set for a particular term or query such that when that number of empty results is returned, action can be taken to “mine” data that matches the query. In addition, a predetermined frequency of empty results may be set such that if a predetermined number of empty results are returned for a particular query within a given time period, action may be taken to mine data that matches the query.

Actions that may be taken to mine data may include assembling data related to the query. For example, consider a query input by a user on a web browser for a particular product. If the query results are empty a given number of times (and, perhaps, within a predetermined time period), data may be assembled by conducting a search for similar products and suppliers of products. According to an exemplary embodiment, this search may be a multi-directed search, from a varied selection of references. The search may be conducted automatically, manually, or through some combination of automatic/manual searching. The search may include modifying one or more terms of the query, e.g., making various spelling changes by replacing vowels, checking a list of common misspellings. The search may be based on keywords or key terms within the user query. The type of search may vary depending on the query, e.g., depending on the category of the query. For example, in the case of a search query concerning a product, the search may include various sources of information regarding products, e.g., trademarks, and copyrights, patent publications, issued patents, and even invention disclosures. If the search query relates to a business, the search for data may include a manual or on-line search of Yellow Pages or White Pages listings keywords within the search query, calling directory assistance, calling Chambers of Commerce or Better Business Bureaus, etc.

As data is assembled, it may be maintained in a source database which may then queried to determine entities related to the search query. For example, using the search query related to a product as an example, the source database may be populated with information related to suppliers of the product, using searching techniques such as those described above. One or more suppliers of the products may then be contacted and can be presented with statistics indicating the number/frequency of empty results, showing the demand for data related to the supplier's products. The supplier(s) may then be provided with an offer including, for example, a sales presentation, inviting the supplier(s) to establish a regarding establishing a web presence. This would be very useful, in particular, for making information that is usually transferred by word of mouth available to a wider audience. This would allow the supplier(s) of the product(s) to conduct a target marketing campaign. In this manner, potential web customers may be found by exploring queries made to a web search engine that do not return any results. Of course, data may also be mined from sources other than suppliers of products, e.g., service suppliers, non-profit organizations, government agencies, or any other entity that may be a source of data that users are interested in but cannot easily obtain access to via the Internet or other shared communications network.

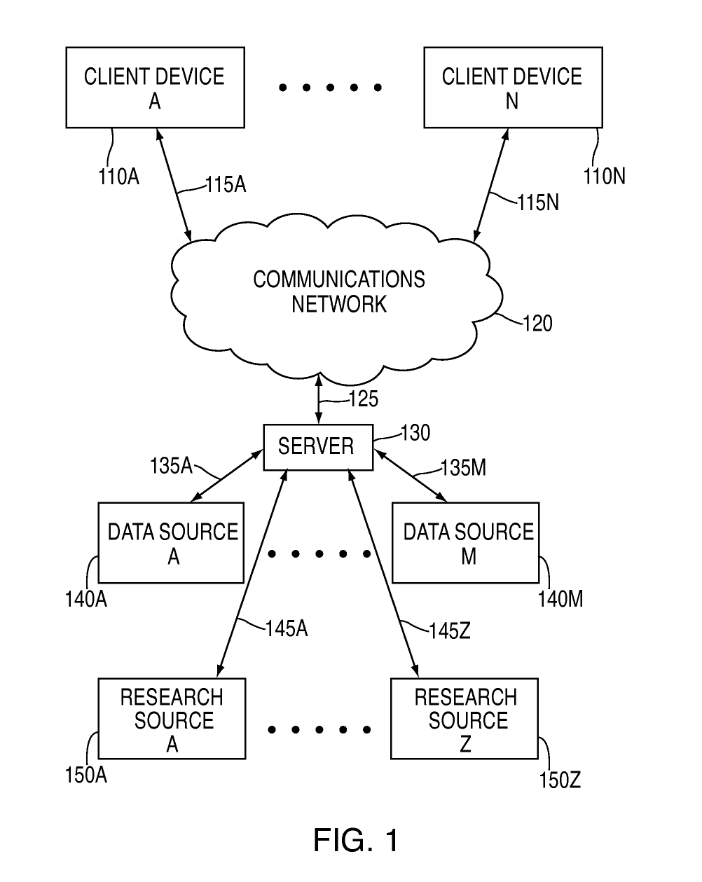

FIG. 1 illustrates a system in which data mining data be implemented according to an exemplary embodiment. In FIG. 1, client devices 110A-110N are connected via a shared communications network 120 to a server 130. The client devices may include, for example, personal computers, PDAs, interactive televisions/set top boxes, cellular telephones, etc. The shared communications network 120 may be the Internet or any other shared communications network, such as an Intranet, a LAN, a WAN, etc. The connections 115A-115N may be include any suitable connection for connecting a particular client device to the network 120, e.g., a dial-up connection, high-speed cable connection, satellite connection, etc. Each client device may include a browser to facilitate communication with the network 120. The server 130 may be, e.g., a web server that is part of the shared communications network 120 or connected to it via a suitable connection 125. The server 130 is, in turn, connected to one or more data sources 140A-140M via connections 135A-135M. These connections may include any connection suitable for contacting the data sources, including but not limited to email, telephone connections, standard mail service, in-person contacts, etc. The server 130 is also connected to research sources 150A-150Z for assembling data to identify the data sources 140A-140M. The research sources may include databases searchable automatically or manually. The server 130 may be connected to the research sources 150A-150Z via any suitable connection, including but not limited to email, Internet, telephone/cellphone service, etc. The shared communications network 120 may, itself, be a research source.

According to an exemplary embodiment, a technique is provided that will allow a user to almost always find what he or she is looking for via the Internet or some other shared communications network. In one embodiment, this technique provides an incentive for businesses to populate the Internet with data, by inviting sellers to post information regarding their products/services based on queries from potential buyers, effectively “matching” buyers with sellers. The technique described herein provides a “smart” way of searching and matching buyers to sellers and maintains such information such that future queries that would otherwise return empty results instead return results helpful both to the searcher (potential buyer) and data source (seller). Of course, the same technique may also be beneficial for a searcher that is a seller searching for a potential buyer that may not have data posted on the Internet.

While the embodiment described above is directed to buyers and sellers, it should be appreciated that the techniques described herein may be applicable and helpful to any searcher and data source.

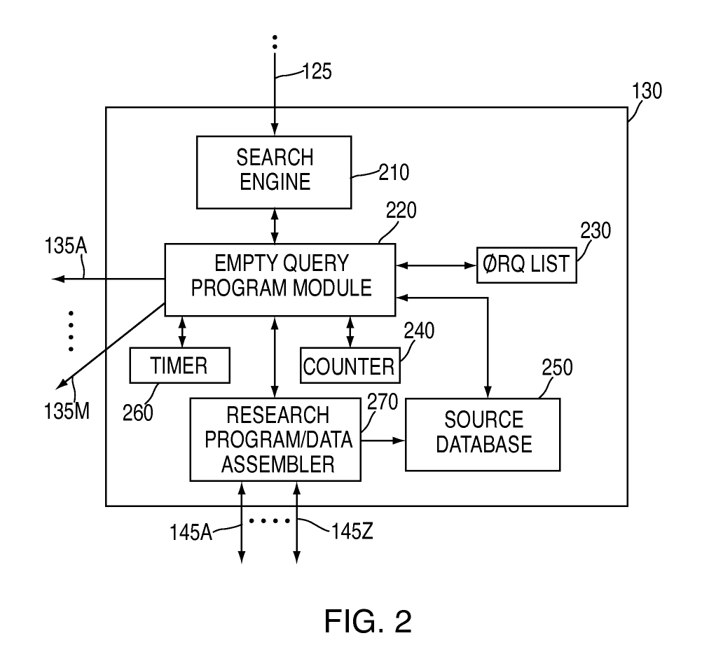

FIG. 2 illustrates details of a device for mining data according to an exemplary embodiment. The device may be implemented, for example, in the web server 130 shown in FIG. 1. Referring to FIG. 2, the server includes a search engine 210, an empty query program module 220, a counter 240, a source database 250, a list of zero search queries (0rq list) 230, a timer 260, and a research program/data assembler 270. Although shown as distinct components, it should be appreciated that one or more of these components may be integrated within, e.g., a microprocessor.

The search engine 210 may work in a conventional fashion to retrieve data from, e.g., website in response to user queries. If the results provided by the search engine are “empty”, i.e., the search engine provides zero matches to the query from the user, the user may be prompted again to enter the query. If the query still results in an empty result, the empty query program module 220 may collect the terms used for the query that resulted in an empty result. This query may be referred to as an “0rq” (zero results query).

The program module 220 may determine if the 0rq is already on the 0rq list 230. If the 0rq is not on the list, it may be added, and a counter 240 may be set to one. If the 0rq is on the list 230, the counter 240 may be incremented by one to indicate the number of times an empty search result has occurred for that particular query. In this manner, the program module 220, in conjunction with the counter 240, may keep track of the number of times an 0rq has occurred, i.e., how many times the same query results in zero results. The program module 220 may also check whether the counter 240 has reached a predetermined limit, e.g., 20 hits. In addition, a timer 260 may be included to enable the program module 220 to keep track of the number of occurrences of a 0rq over a specific time period, e.g., one hour. This provides an indication as to the frequency of occurrence of the 0rq. Thus, the program module 220, in conjunction with the counter 240 and the timer 260 may also check whether a predetermined number of 0rqs have occurred over a predetermined time period. If the number of times an empty result is returned is to be kept track of over a specific time period, the counter may be reset at the beginning of the time period. Otherwise, the counter may just keep track of the total number of times a 0rq occurs.

Once the 0rq limit is reached, based either on the counter or on the counter and the timer, 0rq research may be initiated using the research program/data assembler 270 to assemble data related to one or more particular terms in the query. This may involve creating a list of query contexts and next moves. For example, context of a query may be “product”, and the next moves may include: find product, find source, and end research. As part of finding the product, similar products may be determined. As part of finding the source, the category of the term(s) may be determined, and sources within similar categories may be identified. The searching techniques described above may be used to determine data sources having data that may be relevant to the 0rq, with the research program/data assembler accumulating data via connections 145A-145Z. Data related to the data sources may be maintained in the source database 250. After these operations are completed, a determination may be made whether to pursue contact with potential data sources. This determination may be made by the empty query program module 220, based, e.g., on the relevance of the data source to the terms in the query, based on the sophistication of the potential contact and the likelihood that the contact would want data posted on the Internet, etc. This type of information may be assembled as part the search for sources of data related to the search query and provided to the empty query program module 220 to determine whether to pursue contact with the potential data source. If the decision is made to contact one or more potential data sources, the empty query program module 220 may communicate with the source database 250 containing information regarding sources that may have data matching the requested data, e.g., merchants selling particular products or offering particular services, charity originations providing particular services, etc. If there is a match between the information in the source database and the data in the query, the data source may be contacted.

If the data source is contacted, the search engine statistics may be presented to show the data source the number of queries for the product that produced empty results. The data source may then be given the opportunity to include the information on a web listing or post it on some other type of shared communications network, such that users will be able to find information related to the source.

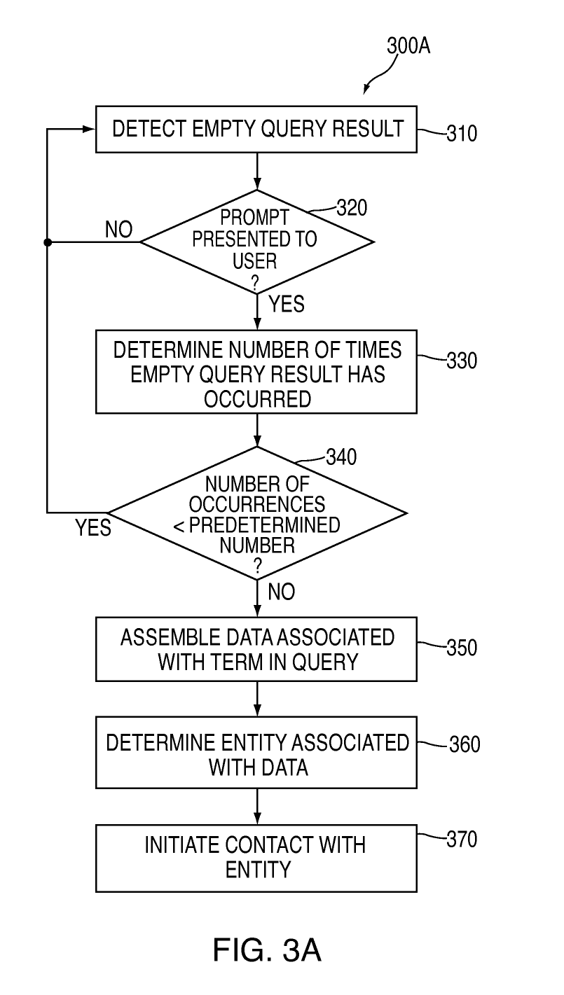

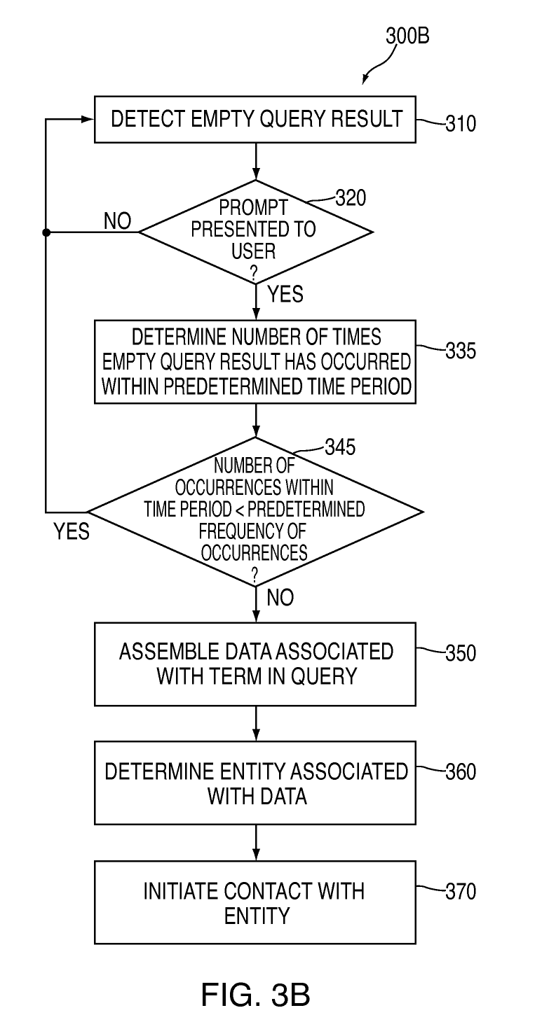

FIGS. 3A and 3B illustrate methods 300A and 300B for mining data according to exemplary embodiments. These methods are similar, and steps that are common to both are labeled with the same reference numbers.

Referring to the method 300A shown in FIG. 3A, the method begins at step 310 at which an empty query result is detected for a particular query. As an optional step, a determination may be made whether a prompt is presented to the user to reenter the query at step 320. The prompt may include, e.g., a suggested alternate spelling. If a prompt is not presented, the method may return to step 310. Presenting a prompt to the user to reenter the query provides the user with the opportunity to correct any errors in the query that led to an empty result. This step is not required, but it is beneficial and results in more effective mining of data.

At step 330, a determination is made as to the number of empty query results that have occurred for a given query or query term. At step 340, a determination is made whether the number of occurrences of the empty query result is less than a predetermined number. This “cut-off” number may be established, e.g., by a service provider, to trigger mining of data from data sources to post on the shared communications network. If the number of occurrences is less than the predetermined number, the method returns to step 310. If the number is not less than the predetermined number, this suggests that the query (or at least one term in the query) is associated with data that a sufficient number of users may be interested in to motivate a data source to post the data on the shared communications network. Accordingly, at step 350 data associated with the term(s) in the query is assembled, such as context, product, etc., and one or more entities (data sources) associated with the assembled data is determined at step 360. Finally, at step 370, contact may be is initiated with at least one entity, inviting the entity to post data on the shared communications network. As part of this invitation, the entity may be provided with the number of empty query results and the query terms entered to indicate that there is interest in the data with which the entity is associated.

FIG. 3B illustrates a similar method 300B for mining data, including steps 310 and optional step 320. However, instead of just determining the number of times empty query results have occurred for a given query or term, this determination is made over a predetermined time period at step 335. Thus, this method determines the frequency of empty query results within a predetermined time period. This frequency of occurrences within the time period is then compared with a predetermined frequency of occurrences at step 345. This predetermined “cut-off” frequency may be established, e.g., by a service provider, to trigger mining of data from data sources to post on the shared communications network. If the frequency of occurrences within the predetermined time period is not less than the predetermined frequency, steps 350-370 may be performed as in FIG. 3A. Otherwise, the method returns to step 310.

Although not depicted in FIGS. 3A and 3B, it should be appreciated that a decision step may be included to determine whether to contact the entities associated with the data in the search query. This determination may be made by the empty query program module based, e.g., on the relevance of the data source to the term(s) in the query, based on the likelihood that the entity will have an interest in posting data, etc., as described above with reference to FIG. 2.

As described above, embodiments can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for mining data, comprising:
detecting an empty query result provided in response to a query for data on a shared communications network;
assembling data associated with at least one term within the query;
determining at least one entity associated with the assembled data; and
initiating contact with the entity to invite posting of the data on the shared communications network.

2. The method of claim 1, further comprising detecting whether a prompt has been presented to offer a user to reenter the query, wherein the steps of assembling, determining, and initiating contact occur only if the prompt has been presented.

3. The method of claim 1, further comprising determining the number of times an empty query result has been detected for at least one term in a particular query.

4. The method of claim 3, wherein the number of times an empty query result has been detected for at least one term in a particular query is determined over a predetermined time period.

5. The method of claim 3, wherein the steps of assembling, determining, and initiating contact are only performed after an empty query result has been detected for a at least one particular term within the query a predetermined number of times.

6. The method of claim 4, wherein the steps of assembling, determining, and initiating contact are only performed after a predetermined frequency of occurrences of empty query results has been detected during the predetermined time period.

7. The method of claim 4, wherein the entity is provided with statistics showing the number and frequency of empty search results.

8. A computer program product for mining data, comprising a computer usable medium having a computer readable program, wherein the computer readable medium when executed on a computer, causes the computer to:
detect an empty query result returned in response to a query on a shared communications network;
assemble data associated with at least one term in the query;
determine at least one entity associated with the data; and
initiate contact with the entity to invite posting of the data on the shared communications network.

9. The computer program product of claim 8, wherein the computer readable medium further causes the computer to detect whether a prompt has been presented to offer a user to reenter the query, wherein the computer readable medium only causes the computer to assemble data, determine at least one entity, and initiate contact if the prompt has been presented.

10. The computer program product of claim 8, wherein the computer readable medium further causes the computer to determine the number of times an empty query result has been detected.

11. The computer program product of claim 10, wherein the number of times an empty query results has been detected is determined over a predetermined time period.

12. The computer program product of claim 10, wherein the computer readable medium only causes the computer to assemble data, determine at least one entity, and initiate contact after an empty query result has been detected a predetermined number of times.

13. The computer program product of claim 11, wherein the computer readable medium causes the computer to assemble data, determine at least one entity, and initiate contact only after a predetermined frequency of occurrences of empty query results has been detected during the predetermined time period.

14. The computer program product of claim 11, wherein the entity is provided with statistics showing the number and frequency of empty search results.

15. As system for mining data, comprising:
a program module for detecting an empty query result in response to a query on a shared communications network;
a source database containing data associated with at least one term in the query, wherein the program module assembles data associated with the at least one term in the query and determines at least one entity associated with the data by consulting the source database; and
an output for initiating contact with the entity to invite posting of the data on the shared communications network.

16. The system of claim 15, further comprising a counter for keeping track of the number of times an empty query result has been detected.

17. This system of claim 16, wherein the counter keeps track of the number of times an empty query result has been detected over a predetermined time period.

18. The system of claim 16, wherein the data is assembled, an entity is determined, and contact is initiated only after an empty query results has been detected a predetermined number of times.

19. The system of claim 17, wherein the data is assembled, an entity is determined, and contact is initiated only after a predetermined frequency of occurrences of empty query results has been detected during the predetermined time period.

20. The system of claim 17, wherein the entity is provided with statistics showing the number and frequency of empty search results.
